(19) United States
(12) Patent Application Publication
(10) Pub. No.: US 2008/0053491 A1
(43) Pub. Date: Mar. 6, 2008

(54) WAFER PROTECTION SYSTEM EMPLOYED IN CHEMICAL STATIONS

(76) Inventors: San-Lung Chen, Ping-Tung Hsien (TW); Ying-Fang Chen, Tai-Chung City (TW); Kuo-Zhang Chu, Kao-Hsiung City (TW); Mei-Lun Tseng, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/930,137

(22) Filed: Oct. 31, 2007

Related U.S. Application Data
(62) Division of application No. 11/162,146, filed on Aug. 30, 2005.

(51) Int. Cl. B08B 3/06

(52) U.S. Cl. 134/36

(57) ABSTRACT

Semiconductor wafers have ashed photoresist residue and/or post-etch residue thereon to be cleaned through the chemical wet station, and a pattern of exposed metal layer. Post-etch residue removing solvent such as EKC-270 is fed into the solvent tank through a first solvent valve and first liquid feeding conduit that connected to bottom of the solvent tank. A circulation conduit connects the solvent tank with the first liquid feeding conduit for circulating the post-etch residue removing solvent. A liquid feeding pump is connected with the first liquid feeding conduit. A liquid drain conduit and a drain valve are connected with bottom of the solvent tank. Replacement solvent such as EKC-800 is fed into the solvent tank through a second solvent valve and second liquid feeding conduit.

### CROSS REFERENCE TO RELATED APPLICATIONS

This application claims priority from U.S. application Ser. No. 11/162,146 by Chen et al., filed Aug. 30, 2005, entitled “Wafer Protection System Employed In Chemical Stations.”

### BACKGROUND OF THE INVENTION

1. Field of the Invention

The present invention relates to the field of semiconductor fabrication and, more particularly, to a wafer protection system employed in batch-type chemical wet station, which is capable of preventing the wafer from being impaired by aggressive cleaning solvent (post-etch residue cleaning solvent) due to unexpected overtime immersion.

2. Description of the Prior Art

During the fabrication of microcircuits, photoresist material is used to pattern, and transfer patterns onto the appropriate material. For example at interconnect levels the appropriate material will be either metal for electrically conducting paths or dielectric for isolating material in-between the conducting lines. Traditional interconnects are made of aluminum or aluminum alloys isolated by dielectric material, for example silicon dioxide. Recently developed interconnects use copper as the conducting material and low-k dielectric material (a dielectric having a dielectric constant smaller than the dielectric constant of silicon dioxide).

A photoresist film is deposited on the wafer to form a mask, then a substrate design is imaged on the film layer, baked, and the undeveloped image is removed with a developer. The remaining image is then transferred to the underlying material (either a dielectric or metal) through etching with reactive etching gases promoted with plasma energy. The remaining photoresist is then stripped off by oxygen plasma, which is also referred to as “photoresist ashing”.

Plasma etching or reactive ion etching produce undesirable by-products from the interaction of the plasma gases, reacted species and the photoresist. The composition of such by-products is generally made up of the etched substrates, underlying substrate, photoresist and etching gases. The formation of such by-products is influenced by the type of etching equipment, process conditions and substrates utilized. These by-products are generally referred to as “sidewall polymer” and cannot be removed completely by oxygen plasma.

If etching residue is not removed from the substrate, the residue can interfere with subsequent processes involving the substrate. In a typical dual damascene process sequence, the trench is exposed to residues generated during both the trench and via etching. This can result in substantial buildup of polymer materials on the trench sidewalls and tops. In the worst case these residues can pinch-off the trench, preventing adequate Cu fill, which can result in high interconnect resistance; or the polymer residues may act as leakage paths for current, resulting in higher cross talk and increased propagation delays.

The need to effectively remove postetch residue, post-ash residue and photoresist from a substrate becomes more critical as the industry progresses into submicron processing techniques. The requirement for cleaning solutions that remove all types of residue generated as a result of plasma etching of various types of metals, such as aluminum, aluminum/silicon/copper, titanium, titanium nitride, titanium/tungsten, tungsten, silicon oxide, polysilicon crystal, etc., while not corroding the underlying metal presents a need for more effective chemistry in the processing area.

In addition to effectively cleaning residues, it is important to prevent Cu corrosion during immersion processing. Previous studies have characterized metal corrosion in back-end-of-line (BEOL) processes and their subsequent rinses. Results from these studies demonstrated that metal corrosion most often occurs during the rinse process that follows the cleaning chemistry, and is the result of interactions between the process chemistry of the wafer surface carryover layer with the subsequent DI rinse water. A common solution to this problem is to employ an intermediate solvent rinse step (usually a commercial rinse chemical) prior to the final DI water rinse step.

Typically, cleaning strategies for BEOL processes have involved one or more batch-type solvent cleaning steps, an intermediate post-solvent rinse (IPR) step, and a final DI water rinse step. FIG. 1 is a schematic diagram illustrating the prior art scheme of chemical station 10 for wafer cleaning. In FIG. 1, wafers 12 after treated by conventional oxygen plasma ashing 20 for removing photoresist are transferred to immerse in the solvent tank 14 containing post-etch residue removing solvent such as hydroxyl amine, etc., for a time period of about 5-30 minutes. After this, the wafers 12 are removed from the solvent tank 14 using a robot and transferred to the IPR tank 16 containing photoresist removing solvent. In the IPR tank 16 the above-described intermediate post-solvent rinse is implemented. Thereafter, the wafers 12 are immersed into the DI water tank 18 to implement DI water rinse. Finally, the wafers 12 are transferred to wafer drying station 30.

However, the above-described prior art chemical station lacks of a wafer protection mechanism that is able to cope with emergency situations such as failure or malfunction of the wafer transferring robot or the like which results in unexpected wafer overtime immersion in the solvent tank.

### SUMMARY OF THE INVENTION

It is therefore the primary object of the present invention to provide an improved chemical station including a wafer protection system that is capable of preventing the wafer from being impaired by aggressive cleaning solvent due to unexpected overtime immersion in a controlled, automated fashion.

According to the claimed invention, a wafer protection system for chemical wet station is disclosed. The chemical wet station comprises a solvent tank for receiving semiconductor wafer previously treated by oxygen plasma ashing process, a succeeding intermediate post-solvent rinse (IPR) tank, a succeeding quick dump rinse (QDR) tank, and a final rinse tank. Semiconductor wafers have ashed photoresist residue and/or post-etch residue thereon to be cleaned through the chemical wet station, and a pattern of exposed metal layer. Post-etch residue removing solvent such as EKC-270 is fed into the solvent tank through a first solvent valve and first liquid feeding conduit that connected to bottom of the solvent tank. A circulation conduit connects the solvent tank with the first liquid feeding conduit for circulating the post-etch residue removing solvent. A liquid feeding pump is connected with the first liquid feeding conduit. A liquid drain conduit and a drain valve are connected with bottom of the solvent tank. Replacement solvent such as EKC-800 is fed into the solvent tank through a second solvent valve and second liquid feeding conduit.

Once bath of the semiconductor wafer initially immersed in the post-etch residue removing solvent in the solvent tank exceeds a set time limit, the drain valve is automatically switched on to drain the solvent tank of post-etch residue removing solvent; when the post-etch residue removing solvent is drained off, the drain valve is switched off, and the second solvent valve is switched on to feed the replacement solvent into the solvent tank through the second liquid feeding conduit to replace the post-etch residue removing solvent.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the prior art scheme of chemical station for wafer cleaning;

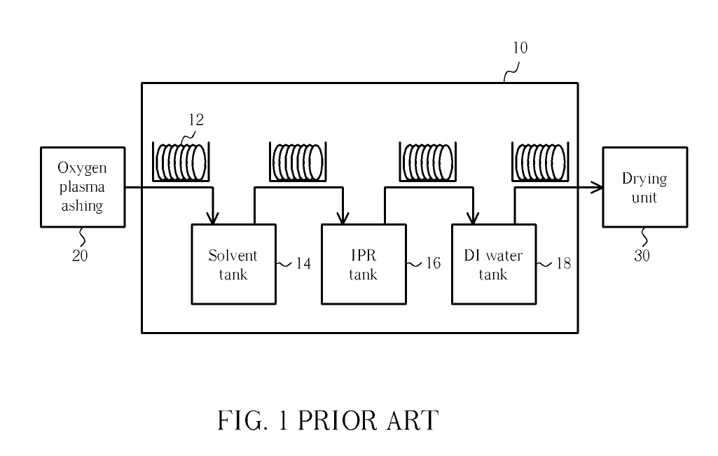

FIG. 2 is a schematic diagram illustrating the scheme of chemical station for wafer cleaning in accordance with the preferred embodiment of the present invention; and

FIG. 3 is a schematic view of the solvent tank in combination with the wafer protection system in accordance with the preferred embodiment of the present invention.

### DETAILED DESCRIPTION

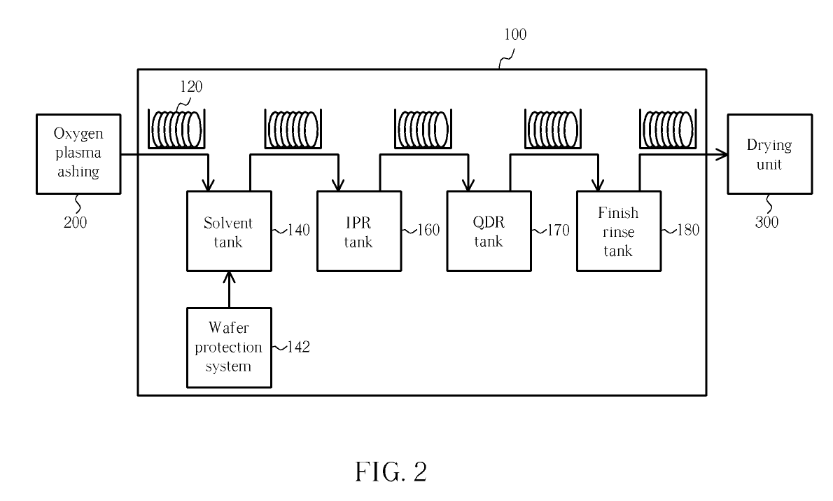

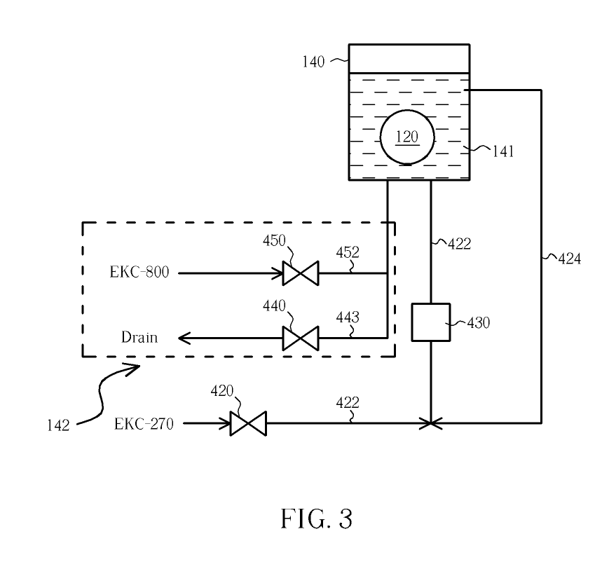

The present invention pertains to a wafer protection system in wet stations, which is capable of preventing the wafers from being impaired by aggressive cleaning solvent or chemical solution due to overtime immersion in one bath. In describing the preferred embodiment of the present invention, reference will be made herein to FIGS. 2-3 of the drawings. Features of the invention are not necessarily drawn to scale in the drawings.

It is understood that organic postetch residue, post-ash residue, and bulk photoresist are removed from wafer surfaces using various chemicals. While these chemicals are generally classed as mixtures of solvents, amines, corrosion inhibitors, and suspending agents, the specific formulations are often proprietary and can vary depending on the application.

FIG. 2 is a schematic diagram illustrating the scheme of chemical station for wafer cleaning in accordance with the preferred embodiment of the present invention. In FIG. 2, wafers 120 after treated by conventional oxygen plasma ashing 200 for removing photoresist are transferred to immerse in the solvent tank 140 containing post-etch residue removing solvent such as hydroxyl amine, etc., for a time period of about 5-30 minutes, preferably 25 minutes. According to the preferred embodiment, the wafer 120 has exposed metal patterns such as aluminum wiring thereon, and the post-etch residue removing solvent includes EKC-270.

EKC-270 is a commercial post-etch residue remover with improved Ti compatibility, and is formulated to remove ashed photoresist residue, organic polymer, and organicmetallic etch residue. The wafers 120 are protected by a wafer protection system 142 in combination with the solvent tank 140. Once the bath of the wafers 120 immersed in the post-etch residue removing solvent in the solvent tank 140 exceeds a set time limit, for example, 40 minutes, the wafer protection system 142 is activated. The unexpected overtime bath might be due to malfunction of the wafer transferring robot or other causes. The overtime bath of the semiconductor wafer in the post-etch residue removing solvent such as EKC-270 impairs the integrity of the metal patterns formed on the wafer.

Referring to FIG. 3, a schematic view of the solvent tank 140 in combination with the wafer protection system 142 is illustrated. As shown in FIG. 3, the wafers 120 are dipped in the post-etch residue removing solvent 141, such as EKC-270. The EKC-270 solution is fed into the solvent tank 140 through solvent valve 420 and liquid feeding conduit 422. The liquid feeding conduit 422 is connected with a liquid feeding pump 430. A circulation conduit 424 connects the solvent tank 140 with the liquid feeding conduit 422 for circulating the post-etch residue removing solvent 141. The bottom of the solvent tank 140 is connected with a liquid drain conduit 443. The solvent tank 140 may be a sealed container with a lid (not shown) that can be opened or closed.

Once the bath of the wafers 120 immersed in the post-etch residue removing solvent in the solvent tank 140 exceeds a set time limit, the drain valve 440 is automatically switched on to drain the solvent tank 140 of post-etch residue removing solvent 141. Once the post-etch residue removing solvent 141 is drained off, the drain valve 440 is switched off, and the solvent valve 450 is switched on to feed a mild solvent (replacement solvent) such as EKC-800 or NMP solution into the solvent tank 140 through the replacement solvent feeding conduit 452 to replace the aggressive EKC-270. In such manner, the wafers 120 are immersed in the mild solvent such as EKC-800 till the wafer-transferring robot is repaired. The liquid feeding pump 430 proceeds to circulate the mild solvent through the circulation conduit 424 and the liquid feeding conduit 422 (with the solvent valve 420 off).

Since a small part of the post-etch residue removing solvent 141 is remained in the circulation conduit 424 and in the liquid feeding conduit 422, which is not drained through the drain valve 440 at first, it is strongly recommended that the circulated mild solvent (EKC-800) should be drained off every 1-3 hours dip, preferably every two-hour dip. It is to be understood that the solvent valves and drain valve are control valves such as magnetic valves or on/off valves which are connected to a control unit (not shown).

Referring back to FIG. 2, once the problems causing the shutdown of the wet station have been tackled and the wet station is recovered, the wafers 120 now dipped in a mild solvent such as EKC-800 are immediately removed out from the solvent tank 140 and transferred to the succeeding tank, the IPR tank 16, which contains photoresist removing solvent. In accordance with the preferred embodiment, the photoresist removing solvent may include EKC-800. In the IPR tank 160, an intermediate post-solvent rinse is implemented for a time period of about 500 seconds for example.

Thereafter, the wafers 120 are immersed into the quick dump rinse (QDR) tank 170 to implement DI water quick dump rinse. After this, the wafers 120 are immersed into the DI water tank 180 to implement final DI water rinse. Finally, the wafers 12 are transferred to wafer drying station 300.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wafer cleaning process, comprising:
immersing a wafer in a post-etch residue removing solvent in a solvent tank, wherein said solvent tank is connected to a circulation conduit, and wherein a liquid drain conduit and a drain valve are connected to bottom of said solvent tank, and a replacement solvent can be fed into said solvent tank through a solvent valve and liquid feeding conduit;
switching on said drain valve to drain said solvent tank of post-etch residue removing solvent when bath of said semiconductor wafer immersed in said post-etch residue removing solvent in said solvent tank exceeds a set time limit; and
switching on said solvent valve to feed said replacement solvent into said solvent tank through said second liquid feeding conduit to replace said post-etch residue removing solvent.

2. The wafer cleaning process according to claim 1 wherein said post-etch residue removing solvent includes amine-based solvent.

3. The wafer cleaning process according to claim 2 wherein said amine-based solvent comprises hydroxylamine.

4. The wafer cleaning process according to claim 2 wherein said amine-based solvent includes EKC-270.

5. The wafer cleaning process according to claim 1 wherein said replacement solvent includes EKC-800 or NMP solution.

6. The wafer cleaning process according to claim 1 wherein said replacement solvent is drained off every 1-3 hours dip.

7. The wafer cleaning apparatus according to claim 1 wherein said set time limit is 5-30 minutes.
